(19) United States
(12) Patent Application Publication
(10) Pub. No.: US 2002/0072821 A1
(43) Pub. Date: Jun. 13, 2002

(54) Parametric input to a design and production system

(76) Inventor: Gregg S. Baker, Geneva, FL (US)

Correspondence Address: FINNEGAN, HENDERSON, FARABOW, GARRETT &, DUNNER LLP, 1300 I STREET, NW, WASHINGTON, DC, 20005, US

(21) Appl. No.: 09/733,054

(22) Filed: Dec. 11, 2000

(51) Int. Cl. G06F 19/00

(52) U.S. Cl. 700/98; 700/118; 700/163

(57) ABSTRACT

A design and production system that takes advantage of open network technology to allow a party outside of a manufacturer's closed production system to operate the manufacturer's production function. The user of the system enters parametric data defining a desired product. The design and production system creates a final design based on the entered parametric data, creates a set of machine instructions according to the final design, and executes the machine instructions using various tools of a production system. The present invention provides the customer with the precise product desired and minimizes the associated cost to the manufacturer of maintaining an inventory of finished goods.

### DESCRIPTION OF THE INVENTION

1. Field of the Invention

The present invention relates to a system and a method for allowing a user to create a desired product by directly inputting design parameters of the product into a manufacturer's design and production systems via an electronic communication network regardless of the user's location.

2. Background of the Invention

Historically, flexible manufacturing systems (FMS) have been implemented that combined a classic computer aided design (CAD) system with a classic computer aided manufacturing (CAM) system. These flexible manufacturing systems offered a significant improvement in overall production efficiency by allowing products to be manufactured more quickly and at lower cost. An additional level of sophistication was realized with the introduction of computer integrated manufacturing (CIM) systems, which wrapped the non-production functions of the manufacturing business enterprise around the FMS. With the CIM systems, activities such as raw material purchasing, invoicing, and shipping could interface directly with the actual production functions. Even the most idealized of these conventional systems, however, suffered from operation within a closed network. Without an open system, it was impossible for a user, located at a remote site with respect to the manufacturing facility, to input parametric data into the CAD/CAM system without being part of the closed network. Thus, only those users that were located on site at the manufacturing facility, or party to the closed network, could control the operation of the manufacturing process.

It is accordingly a primary object of the invention to take advantage of open network technology to allow an individual outside the manufacturer's closed network to operate the manufacturer's production function from anywhere in the world and to generate a product meeting the individual's requirements. With the development of the Internet, no longer must an individual be located at the manufacturing facility, or be party to a closed network, in order to control the production function. Using any one of an array of devices connectable to the Internet, the user/customer can input and transfer parametric data relating to a desired product to any manufacturing facility having an Internet connection. By taking advantage of an open network architecture, the parametric data received from the remotely located user can be directly inputted into the design and production system at the manufacturing facility. Thus, the remotely located user is capable of taking advantage of a particular manufacturing facility to create a specialized product meeting the specific needs of the user. The present invention provides the user with the precise product desired and minimizes the associated cost to the manufacturer of maintaining an inventory of finished goods.

### SUMMARY OF THE INVENTION

In accordance with the invention, a design and production system is provided that includes an electronic communications network into which a user inputs parametric data relating to a desired product, and a design system that receives the parametric data from the electronic communications network and then generates a final design for the desired product based on the parametric data. The design and production system also includes a manufacturing system that receives the final design from the design system and subsequently creates a set of machine instructions based on the final design, and a production system that receives the set of machine instructions from the manufacturing system and subsequently executes the machine instructions to create the desired product.

Also in accordance with the invention, a method of production is provided that includes the steps of: accepting customer-specified design parameters for a desired product into a communications network; transmitting the design parameters to a design system; completing a final design for the product using the design system; transmitting the final design to a manufacturing system; using the manufacturing system to create machine instructions based on the final design from the design system; transmitting the machine instructions to a production system; and using the production system to execute the machine instructions and to generate the desired product.

Using the method of production of the present invention, it is also possible to accept customer-specified manufacturing parameters for a desired product into a communications network; transmit the manufacturing parameters directly to a manufacturing system; use the manufacturing system to create machine instructions; transmit the machine instructions to a production system; and use the production system to execute the machine instructions and to generate the desired product

Additional objects and advantages of the invention will be set forth in part in the description which follows, and in part will be obvious from the description, or may be learned by practice of the invention. The objects and advantages of the invention will be realized and attained by means of the elements and combinations particularly pointed out in the appended claims.

It is to be understood that both the foregoing general description and the following detailed description are exemplary and explanatory only and are not restrictive of the invention, as claimed.

The accompanying drawings, which are incorporated in and constitute a part of this specification, illustrate several embodiments of the invention and together with the description, serve to explain the principles of the invention.

### BRIEF DESCRIPTION OF THE DRAWINGS

FIG. 1 illustrates a design and production system according to the present invention.

FIG. 2 illustrates a method of production according to the present invention.

### DETAILED DESCRIPTION OF THE INVENTION

Reference will now be made in detail to the various embodiments of the invention, examples of which are illustrated in the accompanying drawings. Wherever possible, the same reference numbers will be used throughout the drawings to refer to the same or like parts.

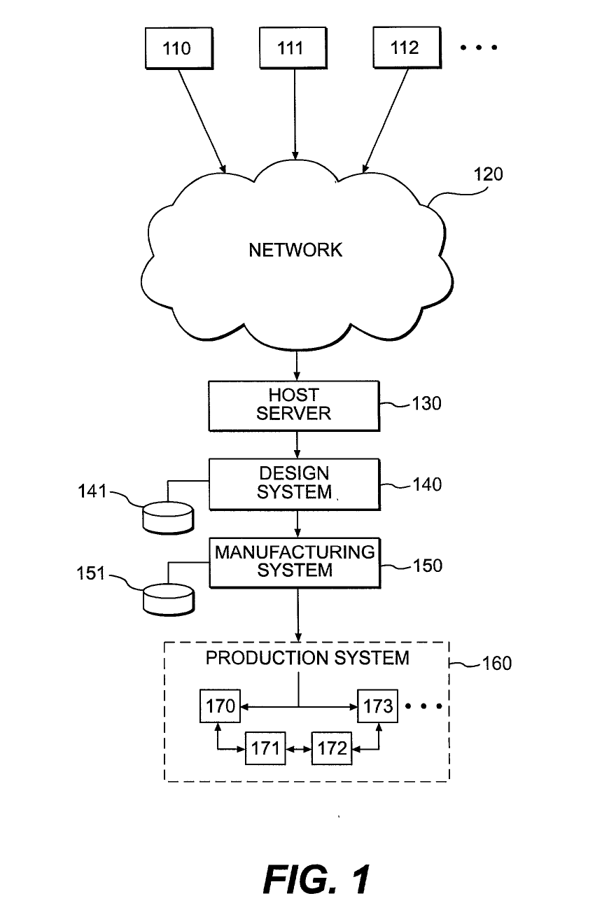

FIG. 1 illustrates a design and production system according to the present invention. At least one user terminal 110 is connected to a network 120, which allows communication with a host server 130, also connected to the network. While the invention is operational with a single user terminal, a plurality of user terminals (110, 111, 112, . . . ) may be connected to the network for communication with the host server 130. Further components of the invention include a design system 140, a design system database 141, a manufacturing system 150, a manufacturing system database 151, and a production system 160 that includes at least one manufacturing tool 170. As necessary, the production system 160 may also include a plurality of manufacturing tools (171, 172, 173, . . . ).

During operation of the design and production system of the present invention, a user, or customer, wishing to fabricate a particular product enters parametric data describing that product into any one of the user terminals. Each user terminal may comprise any device that is connectable to or that can communicate with a network. For example, a user terminal may comprise a portable computer, a desktop computer, a hand-held computing device, a phone, a fax server, or an e-mail server. The parametric data entry may take one or more of several different forms. For instance, the parametric data may be compiled as a list of data that adequately describes the particular elements of the product that the user wishes to customize. In this case, the manufacturer would complete the design of the product by defining the features of the product for which the user did not supply custom data. Alternately, the user may provide a set of parametric data that completely defines the desired product. In yet another implementation, the manufacturer may supply a blank form to the user that prompts the user to specify those parameters that may be customized to create the desired product. Once the user, or agent of the user or manufacturer, has entered the appropriate parametric data into the user terminal, the parametric data is transferred via network 120 to the host server 130, which is associated with a particular manufacturing facility.

In the present invention, the network enables communication between any of the plurality of user terminals and the host server of the manufacturing facility. The network may comprise the Internet, where the host server includes a World Wide Web address that may be accessed by the user terminals. Additionally, the network may comprise an intranet that allows information transfer between the host server of the manufacturing facility and particular user terminals, yet prevents access by other user terminals. Further, the network of the present invention may comprise any method for enabling communication between one or more manufacturing facilities and remotely located users, or customers, or agents of the manufacturer or customer.

The present invention enables a user (for example, a customer or agent of either the customer or the manufacturer, or any intermediary party or parties that are upstream from the manufacturer relative to the flow of information to the manufacturer) to order a product having completely customizable and precise characteristics rather than relying upon goods selected from a fixed inventory of designs or finished goods. To achieve this end, the user directly inputs the design parameters of the product into the manufacturer's design and production system via the user terminal 110, the network 120, and the host server 130. The invention allows for single parameter input as well as complex, multiple parameter input. As an example of a single parameter input, a user wishing to order a three-inch diameter, metal bar will contact a company that manufacturers metal bars. Rather than being limited to the standard lengths of three-inch diameter, metal bars in inventory, the user can specify the particular length desired. Thus, if the user required a three-inch diameter, metal bar having a length of 5.49 inches, then the user would choose the three-inch diameter, metal bar as the product and specify the length of 5.49 inches as the parametric input to the design and manufacturing system.

In addition to this simple example, the invention also allows for multiple parameter input and parameters of higher order. For instance, instead of selecting a metal bar by specifying the length as the only parameter, a user may specify both the length and the diameter. From these two parameters, the user may create a completely custom metal bar having a specific diameter as well as a specific length.

As an example of a higher order parameter, the user may define the desired product by specifying a corner of the product as a point in space, an edge of the product as a line in space, and a surface of the product as three or more points in space (or connected lines). Even more extreme, the user could order a product having a very complex shape by simply referring to a provided shape. That is, the user may communicate a complex shape to the manufacturer by either attaching or referring to a description, which may be contained in an electronic file. The file may take the form of an image, a spreadsheet, or a database communicated to the manufacturer across the network as an attachment to an e-mail or as a direct transmission of the data. As an example, a user desiring production of a medical implant could define the implant, in whole or in part, using a scan of the patient's body. Thus, the output of a computer aided tomographic instrument or a magnetic resonance imaging apparatus could be transferred directly to the manufacturer as an attachment to the order and then be used to create the desired medical implant.

The invention is useful not only for manufacturing metal bars and medical implants, but rather, the invention is useful for manufacturing nearly any conceivable good. The invention extends from raw material sizing specification to the creation of complex parts for use in a vast array of industries. For example, in addition to providing parametric data relating to the geometric definition of a desired product, the user may provide parametric data defining a particular property that the desired product should possess other than or in addition to its geometric definition. In such a case, the final design becomes a function of the desired performance. For instance, in many applications, the particular heat transfer properties of a product are crucial to its operation. In such a case, the user may provide parametric data that details the specific heat transfer properties that the desired product should exhibit. The parametric data specifying the heat transfer properties of the product may be provided to the manufacturer either alone or in combination with structural data for the product.

Once a user has entered the parametric data necessary to fabricate a desired product and has communicated this data to the manufacturer, the manufacturer transfers the parametric data to the design system 140. Using a database 141 that is specific to the design system, the design system creates the final design for the desired product. That is, using a system such as computer aided design (CAD), the design system begins with a foundation design for a product and incorporates the parametric data to further define the product. It may be possible, however, that the parametric data is of such high order, or includes such a plurality of parameters, that the use of a foundation design is unnecessary; the parametric data itself could be sufficient for completing the final design. In creating the final design of the desired product, the parametric data is incorporated into the product design and supplemented as necessary to create the final design. Furthermore, it is also possible that the parametric data itself could comprise the final design. In such a case, the parametric data is passed directly to the manufacturing system 150, bypassing the design system 140. Ultimately, what emerges from the design system is a complete definition of the customized product that serves as a basis for the manufacturing process. For a mechanically oriented product, for instance, the final design may include a complete geometric definition of the product that details all the dimensions of the product necessary for fabricating the product.

The design system 140 and database 141 may comprise a commercially available CAD software package, or it may comprise design software that is tailored to meet the specific needs of a particular manufacturer. The design system 140 and the database 141 may be operated from host server 130, or alternately, they may be operated from a remote location.

Next, manufacturing system 150 is configured to receive the final design from design system 140 and to create machine instructions for creating the desired product. The final design is transmitted to the manufacturing system 150 via the Internet, an intranet, or any other suitable communication method. Alternately, it is possible to simply transfer the final design to the manufacturing system using a transportable medium such as a magnetic storage disk. Once the manufacturing system 150 receives the final design, the manufacturing system uses database 151 to create machine instructions for use by the production system 160 to generate the final product. The manufacturing system 150, like the design system, may comprise a commercially available computer aided manufacturing (CAM) software package. Alternatively, the manufacturing system may comprise a system specifically tailored to meet the requirements of a particular manufacturer. For instance, the manufacturing system 150 may be configured to generate machine instructions that are compatible with a particular set of machines unique to a particular manufacturer. In either case, however, it is desirable for the manufacturing system software to be compatible with the design system software such that the final design from the design system may be transmitted to and utilized by the manufacturing system 150 in a seamless process.

After completing the set of machine instructions based on the final design, the manufacturing system transfers the machine instructions to the production system 160. The production system 160 is responsible for executing each machine instruction necessary for creating the desired product. The production system 160 comprises at least one machine tool 170 but may comprise a plurality of machine tools (171, 172, 173, . . . ) operating as an automated production cell. In the case where the production system comprises more than one tool, an automatic process may be implemented to transfer the product from one machine to the next. As a simple example of a multi-tool production system, tool 170 may comprise a band saw for cutting metal raw material to a particular length. Once the raw material is cut to the desired length, a robotic arm may transfer the partially completed product to the next tool 171, which may comprise a lathe. Tool 171 may further shape the product into a cylindrical rod having a desired diameter. At the end of the process, the production system 160 would discharge the desired product; i.e. a metal rod with a length and diameter matching the parametric data input by the user. It is not necessary, however, that the production system 160 function as a stand-alone, automated unit. For example, the production system 160 may include human intervention to transfer the work-in-progress to the appropriate machine tools, or to aid in operating any or all of the tools.

Up to this point, the description of the present invention has involved the creation of only mechanical parts or products. The present invention, however, is not limited to the manufacture of mechanical parts. Instead, the invention may also be used to fabricate electronic circuits, to create electro-mechanical systems (for example, a device having both electronic as well as structural features), to mix specific chemical compounds, or to engineer various software applications. Furthermore, the invention is not limited to the creation of single, monolithic parts, but may, instead, be used to create parts of a larger assembly. In fact, the assembly process itself could be an automated operation within the production function.

In order to produce a specific electronic circuit using the present invention, the user would enter parametric data that defines particular elements of the electronic circuit. For instance, the user may specify particular power requirements for different elements of the desired circuit. In designing and fabricating the circuit, the manufacturer would be bound to the user specified requirements in producing the desired product. Similarly, the user may specify particular logical operations of a desired digital logic circuit. The invention, therefore, allows the manufacturer to fabricate both analog and digital circuitry based directly on customer input.

Further, the present invention may be used to mix and prepare specific chemical compounds. As an example, a user may input parametric data that defines a particular color and type of paint. Upon receipt of the parametric data, the manufacturer would finalize the design for the paint using the design system 140. This design would then be transferred to the manufacturing system 150 to create the necessary machine instructions for mixing the paint of the desired type and color. The production system, in this case, could comprise, for example, a paint type selector, color dispensers, paint receptacle handling machines, a mixing machine, and a labeling machine.

Further still, the present invention may be used for engineering and production of software applications. Similar to digital logic or other electronic circuit design, the user may provide parametric input data specifying the desired functionality of a software application. Using, for example, a computer aided software engineering (CASE) tool in the design system 140, a final design for the software application is generated. The manufacturing system 150 would then develop machine instructions for compiling the source code from various libraries and producing the software application on a storage medium. Production system 160 compiles and assembles the code for the desired application and writes the final application to the storage medium according to the instructions from the manufacturing system 150.

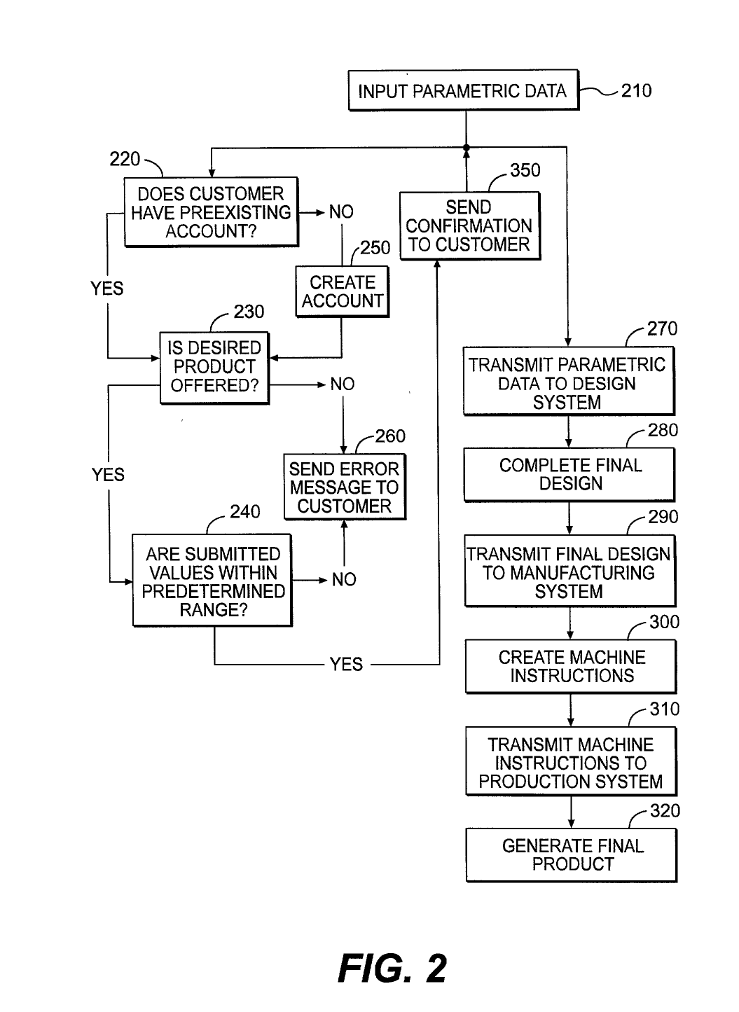

FIG. 2 illustrates a flowchart that is representative of a method of operation of the present invention. At step 210, the user inputs parametric data defining the desired product. This data, as described earlier, may be inputted directly into an electronic communications network, such as the Internet, or it can be relayed by means including a facsimile, telephone, or mail service. Once the parametric data is received, the manufacturer enters it into the electronic communications network if necessary. Once in the system, the data is reviewed to determine if the customer has an established account (step 220); whether the product type is offered by the manufacturer (step 230); and whether the values submitted in the parametric data fall within an acceptable range (step 240). If the customer does not have a preexisting account, then an account is created for the customer (step 250). If either the desired product is one that is not offered by the manufacturer or the values submitted fall outside of an acceptable range, then a message is sent to the customer advising the customer of the problem (step 260). It may be possible to prevent such an occurrence, however, by providing the customer with a form, which may be electronic, which sets forth the allowable product types as well as the allowable ranges for the parametric data. This form may be configured to reject any inputs not falling within the predetermined ranges.

Security could be ensured by providing access to the system via a user ID and a corresponding password for existing customers. Additionally, secure socket link (SSL) encryption between the customer and the manufacturer, electronic signature verification, and other security mechanisms could be used.

Once the data has been received, reviewed, and accepted, a confirmation message is sent to the customer indicating that the parametric data is suitable for the manufacturing process (step 350). The parametric data is then transmitted to the design system (step 270) where a final design for the desired product is completed, step 280. Next, the final design is transmitted to the manufacturing system (step 290), which creates machine instructions (step 300) based on the final design from step 280. These machine instructions are transmitted to the production system (step 310), and the production system executes the machine instructions to generate the desired product (step 320).

Because the network 120, the design system 140, and the manufacturing system 150 may use different database structures, the present invention may be configured to write intermediate files to translate the data as it moves from one operation to the next. These intermediate file structures would vary depending on a particular function. For example, the parametric data input by the user could be translated to a simple text file to be read by the design system 140. Part geometry, or other output, generated by the design system 140 could be exported in a geometry file format such as IGES or DXF, which would be read by the manufacturing system 150.

The present invention is not limited to a fully automated system. Rather, at any point during the review, acceptance, design, manufacturing, and production processes, the present invention allows for human intervention. That is, humans may intervene to provide such additional functions as quality control, order verification, customer communication, data entry, transfers between production system machines, or any other necessary function.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A design and production system comprising:
an electronic communications network into which a user inputs parametric data relating to a desired product;
a design system that receives the parametric data from the electronic communications network and then generates a final design for the desired product based on the parametric data;
a manufacturing system that receives the final design from the design system and subsequently creates a set of machine instructions based on the final design; and
a production system that receives the set of machine instructions from the manufacturing system and subsequently executes the machine instructions to create the desired product.

2. The design and production system of claim 1, wherein said electronic communications network comprises at least one user terminal and at least one host server connectable to the Internet.

3. The design and production system of claim 1, wherein said electronic communications network comprises at least one user terminal capable of establishing a connection to at least one host server.

4. The design and production system of claim 1, wherein said parametric data include electronic circuit design parameters.

5. The design and production system of claim 4, wherein said electronic circuit design parameters comprise digital logic requirements for a desired circuit.

6. The design and production system of claim 4, wherein said electronic circuit design parameters comprise power requirements for a desired circuit.

7. The design and production system of claim 1, wherein said parametric data include both electronic circuit design parameters and structural design parameters necessary for completing a design of an electro-mechanical device.

8. The design and production system of claim 1, wherein said parametric data include dimensional data relating to the desired product.

9. The design and production system of claim 8, wherein said dimensional data is provided as at least one of length, height, and width measurements of the desired product.

10. The design and production system of claim 8, wherein said dimensional data is provided as at least one of a point in space, an edge, and a surface of the desired product.

11. The design and production system of claim 8, wherein said dimensional data includes a human body geometry component.

12. The design and production system of claim 1, wherein said parametric data include heat transfer characteristics for the desired product.

13. The design and production system of claim 1, wherein said parametric data is input in the form of an electronic data file.

14. The design and production system of claim 1, wherein said design system comprises a CAD tool.

15. The design and production system of claim 1, wherein said manufacturing system comprises a CAM tool.

16. The design and production system of claim 1, wherein said design system comprises a logic, power, and electro-mechanical design system.

17. The design and production system of claim 1, wherein said manufacturing system comprises a CASE tool.

18. The design and production system of claim 1, wherein said production system comprises at least one computer-aided machine tool.

19. A method of production comprising:
accepting customer-specified design and/or performance parameters for a desired product into a communications network;
transmitting said design parameters to a design system;
completing a final design for said product using said design system;
transmitting said final design to a manufacturing system;
creating machine instructions based on said final design using said manufacturing system;
transmitting said machine instructions to a production system; and
using the production system to execute said machine instructions and to generate said desired product.

20. The method of production of claim 19, further comprising:
determining whether or not the customer has an account, and creating a new account if the customer does not have an account.
determining whether or not the desired product falls within a category of offered products, and returning an error message to the customer if the desired product does not fall within a category of offered products;
determining whether or not the customer-specified design parameters fall within a predetermined or practical range, and returning an error message to the customer if the customer-specified design and/or performance parameters fall outside the predetermined range; and
sending a confirmation to the customer upon a finding that the design and/or performance parameters are suitable.

21. The method of production of claim 19, wherein said communications network comprises at least one user terminal and at least one host server connectable to the Internet.

22. The method of production of claim 19, wherein said communications network comprises at least one user terminal capable of establishing a connection to at least one host server.

23. The method of production of claim 19, wherein said parametric data include electronic circuit design parameters.

24. The method of production of claim 23, wherein said electronic circuit design parameters comprise digital logic requirements for a desired circuit.

25. The method of production of claim 23, wherein said electronic circuit design parameters comprise power requirements for a desired circuit.

26. The method of production of claim 19, wherein said parametric data include both electronic circuit design parameters and structural design parameters necessary for completing a design of an electro-mechanical device.

27. The method of production of claim 19, wherein said parametric data include dimensional data relating to the desired product.

28. The method of production of claim 27, wherein said dimensional data is provided as at least one of length, height, and width measurements of the desired product.

29. The method of production of claim 27, wherein said dimensional data is provided as at least one of a point in space, an edge, and a surface of the desired product.

30. The method of production of claim 27, wherein said dimensional data includes a human body geometry component.

31. The method of production of claim 19, wherein said parametric data is input in the form of an electronic data file.

32. The method of production of claim 19, wherein said design system comprises a CAD tool.

33. The method of production of claim 19, wherein said manufacturing system comprises a CAM tool.

34. The method of production of claim 19, wherein said design system comprises a logic, power, and electro-mechanical design system.

35. The method of production of claim 19, wherein said manufacturing system comprises a CASE tool.

36. The method of production of claim 19, wherein said production system comprises at least one computer-aided machine tool.

37. A method of production comprising:
accepting customer-specified design and/or performance parameters for a desired product into a communications network;
transmitting said design parameters to a design system;
generating, from said design system, a complete structural definition for the desired product based on said design parameters;
transmitting said complete structural definition for the desired product to a manufacturing system;
generating, from said manufacturing system, machine instructions based on said complete structural definition;
transmitting said machine instructions to a production system; and
executing, via said production system, said machine instructions, wherein executing said machine instructions results in production of the desired product.

38. The method of production of claim 37, wherein said communications network comprises at least one user terminal and at least one host server connectable to the Internet.

39. The method of production of claim 37, wherein said communications network comprises at least one user terminal capable of establishing a connection to at least one host server.

40. The method of production of claim 37, wherein said parametric data include dimensional data relating to the desired product.

41. The method of production of claim 40, wherein said dimensional data is provided as at least one of length, height, and width measurements of the desired product.

42. The method of production of claim 40, wherein said dimensional data is provided as at least one of a point in space, an edge, and a surface of the desired product.

43. The method of production of claim 40, wherein said dimensional data includes a three dimensional specification for a human body component.

44. The method of production of claim 37, wherein said parametric data is input in the form of an electronic data file.

45. The method of production of claim 37, wherein said design system comprises a CAD tool.

46. The method of production of claim 37, wherein said manufacturing system comprises a CAM tool.

47. The method of production of claim 37, wherein said production system comprises at least one computer-aided machine tool.

48. A design and production system comprising:
an electronic communications network into which a user inputs parametric data relating to a desired product;
a design system that receives the parametric data from the electronic communications network and generates a complete structural description of the desired product based on the parametric data;
a manufacturing system that receives the complete structural description of the desired product from the design system and generates machine instructions based on said complete structural description of the desired product; and
a production system that receives the machine instructions from the manufacturing system and executes said machine instructions to create said desired product.

49. The design and production system of claim 48, wherein said electronic communications network comprises at least one user terminal and at least one host server connectable to the Internet.

50. The design and production system of claim 48, wherein said electronic communications network comprises at least one user terminal capable of establishing a connection to at least one host server.

50. The design and production system of claim 48, wherein said parametric data include dimensional data relating to the desired product.

51. The design and production system of claim 50, wherein said dimensional data is provided as at least one of length, height, and width measurements of the desired product.

52. The design and production system of claim 50, wherein said dimensional data is provided as at least one of a point in space, an edge, and a surface of the desired product.

53. The design and production system of claim 50, wherein said dimensional data includes a dimensional specification for a human body component.

54. The design and production system of claim 48, wherein said parametric data is input in the form of an electronic data file.

55. The design and production system of claim 48, wherein said design system comprises a CAD tool.

56. The design and production system of claim 48, wherein said manufacturing system comprises a CAM tool.

57. The design and production system of claim 48, wherein said production system comprises at least one computer-aided machine tool.
